(19) United States
(12) Patent Application Publication
(10) Pub. No.: US 2020/0335075 A1
(43) Pub. Date: Oct. 22, 2020

(54) ACOUSTIC APPARATUS

(71) Applicant: AlphaTheta Corporation, Yokohama-shi, Kanagawa (JP)

(72) Inventors: Nao Takagi, Yokohama-shi, Kanagawa (JP); Daisuke Tanaka, Yokohama-shi, Kanagawa (JP); Hitoshi Kudo, Yokohama-shi, Kanagawa (JP); Takahiro Kuramoto, Yokohama-shi, Kanagawa (JP)

(21) Appl. No.: 16/958,259

(22) PCT Filed: Dec. 29, 2017
(86) PCT No.: PCT/JP2017/047403

§ 371 Date: Jun. 26, 2020

(51) Int. Cl. G10H 1/00

(52) U.S. Cl. CPC G10H 1/0083

(57) ABSTRACT

Sound equipment includes: a display; and mask covering a part of the display. The display includes a first display area where an image is to be freely displayed and a second display area covered with the mask. The mask includes a transmissive portion configured to transmit light emitted from the second display area.

### TECHNICAL FIELD

The present invention relates to sound equipment.

### BACKGROUND ART

According to a typical known technology, a display area of a flat panel display such as a liquid crystal display is partly covered with a mask or the like.

Patent Literature 1 discloses a technology where in a case of displaying contents on a display with a redundant area remaining in a display size of the contents with respect to a display area of the display, the redundant area is covered with a removable mask, thereby displaying a realistic screen image without visually recognizing a black image in the redundant area.

In addition, Patent Literature 2 discloses a technology where a non-see-through mask is provided around a display area of a liquid crystal display provided to a reel or the like to emphasize the display area of the liquid crystal display, thereby making it easy to see a displayed value of a fishing line length or the like appearing on the display area.

### CITATION LIST

### Patent Literature(s)

Patent Literature 1: JP 2007-127717 A

Patent Literature 2: JP 11-196724 A

### SUMMARY OF THE INVENTION

### Problem(s) to be Solved by the Invention

However, the technologies of Patent Literature 1 and Patent Literature 2 mentioned above, which merely allow for improving the reality of the displayed contents or improving the visibility of the displayed value simply by covering a part of the display area of the display, cannot provide a display device with decorativeness In particular, for sound equipment such as DJ equipment, decorativeness is considered to be important and a displaying method that achieves higher decorativeness has been desired.

An object of the invention is to provide sound equipment including a display with a high decorativeness.

### Means for Solving the Problem(s)

According to an aspect of the invention, sound equipment includes: a display; and a mask covering a part of the display, in which the display includes: a first display area where an image is to be freely displayed; and a second display area covered with the mask, and the mask includes a transmissive portion configured to transmit light emitted from the second display area.

### BRIEF DESCRIPTION OF DRAWING(S)

FIG. 1 is a plan view showing a structure of a music piece data reproduction control system according to an exemplary embodiment of the invention.

FIG. 2 is a plan view showing a display of a DJ controller, which is sound equipment according to the exemplary embodiment.

FIG. 3 is a plan view showing a detailed structure of the display according to the exemplary embodiment.

FIG. 4 is an exploded perspective view showing a production method of the display according to the exemplary embodiment.

### DESCRIPTION OF EMBODIMENT(S)

### [1] Overall Configuration

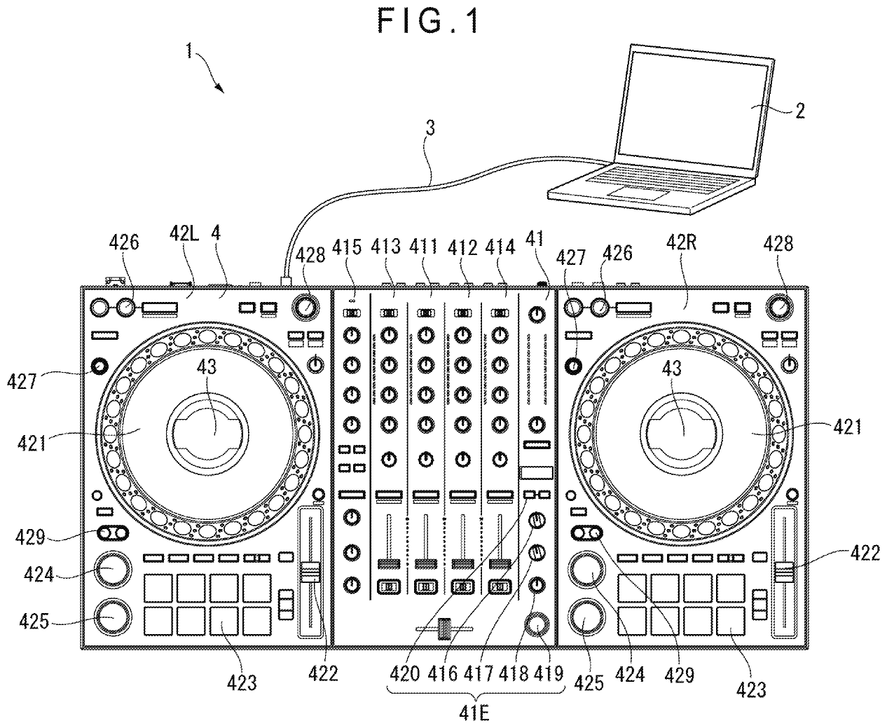

An exemplary embodiment of the invention will be described below with reference to the attached drawings. FIG. 1 shows a music piece reproduction control system 1 according to the exemplary embodiment of the invention, the music piece data reproduction control system 1 including a computer 2 and a DJ controller 4 connected to the computer 2 through a USB cable 3.

The computer 2, which includes a storage such as CPU and a hard disk, is configured to reproduce music piece data stored in MP3 format or the like in the storage. The music piece data is reproduced by application software run on the CPU and the reproduced music piece data is outputted to the DJ controller 4 through the USB cable 3. Further, a reproduction control signal generated by operating a mixer 41 and decks 42L and 42R of the DJ controller 4 is outputted to the USB cable 3 to be inputted to the computer 2. In the computer 2, a variety of sound effects are added to the currently reproduced music piece data in accordance with the reproduction control signal outputted from the DJ controller 4.

The DJ controller 4, which is an example of sound equipment, includes the mixer 41 located at a center thereof and the decks 42L and 42R located at right and left of the mixer 41. It is to be noted that the sound equipment according to the invention refers to a concept including not only sound reproduction controller as in the exemplary embodiment but also a sound reproducer configured to reproduce music piece data.

The mixer 41, which is a section configured to switch audio data outputted from the computer 2, adjust sound volumes of channels, and add a sound effect, includes first channel adjuster 411 to fourth channel adjuster 414 and a microphone adjuster 415.

An effector 41E is provided at a lower right of the mixer 41. In order to add a sound effect to a music piece to be reproduced, the effector 41E includes an effect selection switch 416, a channel selection switch 417, an effect-amount adjusting switch 418, an effect adding switch 419, and a beat change button 420.

The decks 42L and 42R are sections configured to be operated by an operator to add a variety of effects to music piece data outputted from the computer 2. The decks 42L and 42R each include a jog dial 421, a tempo slider 422, a performance pad 423, a cue button 424, a play/pause button 425, a loop button 426, a deck selection button 427, a load button 428, and a cue/loop call switch 429.

The jog dial 421, which is an example of a rotary operation unit, is rotatably provided to a device body of each of the decks 42L and 42R, is configured to fast-forward and reverse music piece data to be reproduced when the operator rotates the jog dial 421.

A display 43, which includes a liquid crystal display, is provided at a center of the jog dial 421. As described later in detail, a BPM (Beats Per Minute) value, an elapsed time, a state of progress, and a beat position of the currently reproduced music piece data and a state of rotation of an LP record at 33 RPM in line with the progress of the currently reproduced music piece data are displayed on the display 43, allowing the operator to see the progress of the reproduction of the music piece data.

The tempo slider 422 is a switch for adjusting a tempo of music piece data to be reproduced. The performance pad 423, which is a button for switching an effect for the currently reproduced music piece data, is configured to add effects, such as loop, cue, key shift, and sampler, to the currently reproduced music piece data instantaneously when pressed by the operator.

The cue button 424 is a button for cuing a music piece to be reproduced.

The play/pause button 425 is a button for starting reproduction of music piece data and pausing the currently reproduced music piece data. The loop button 426 is a button for looping the currently reproduced music piece data.

The deck selection button 427 is a button for selecting which one of the first channel adjuster 411 to the fourth channel adjuster 414 of the mixer 41 is to be used for operating the currently reproduced music piece data. In the exemplary embodiment, the left deck 42L is configured to switch between the first channel adjuster 411 and the third channel adjuster 413 and the right deck 42R is configured to switch between the second channel adjuster 412 and the fourth channel adjuster 414

The cue/loop call switch 429 is a switch for calling a stored cue point.

The load button 428 is a button for loading music piece data from the computer 2. By pressing the load button 428 after music piece data to be reproduced is selected on the computer 2, the music piece data is loaded to a channel of one of the first channel adjuster 411 to the fourth channel adjuster 414.

### [2] Structure of Display 43

The decks 42L and 42R of such a DJ controller 4 are each provided with the display 43. The display 43 is concentrically located around a rotation center of the jog dial 421.

The display 43 in a form of a liquid crystal display has a layered structure of a backlight, a liquid crystal panel, and a color filter.

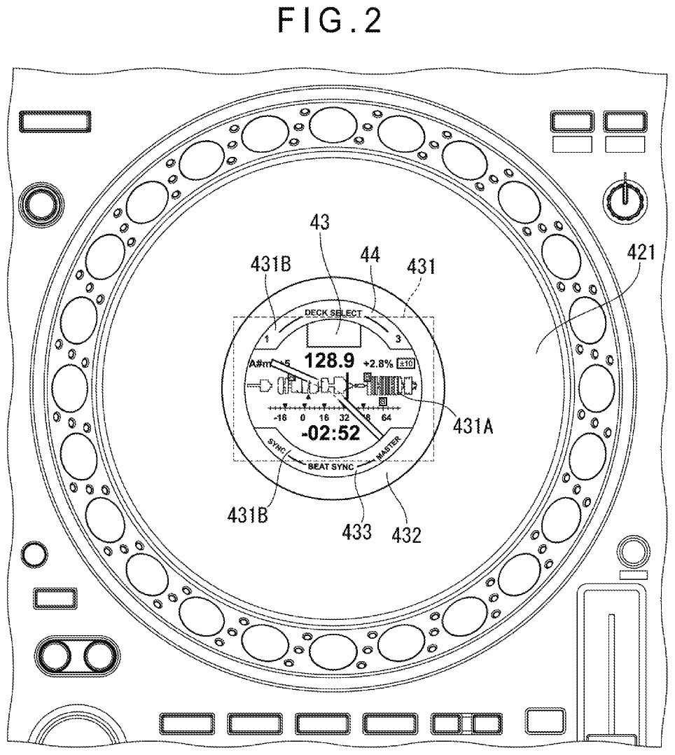

As shown in FIG. 2, the display 43 has a rectangular display area 431 while a ring 432 is provided on the display 43 around the rotation center of the jog dial 421. The display area 431 inside the ring 432 is visible. The display area 431 has a first display area 431A and a second display area 431B. While the jog dial 421 is rotatable around the ring 432, an area provided with the display 43 inside the ring 432 is not rotatable.

The first display area 431A, which is located in a central portion of the display area 431 and externally visible, is configured to freely display an image formed by the liquid crystal display.

The second display area 431B, which is located at a width-direction end of the first display area 431A, is covered with a mask 44 provided inside the ring 432.

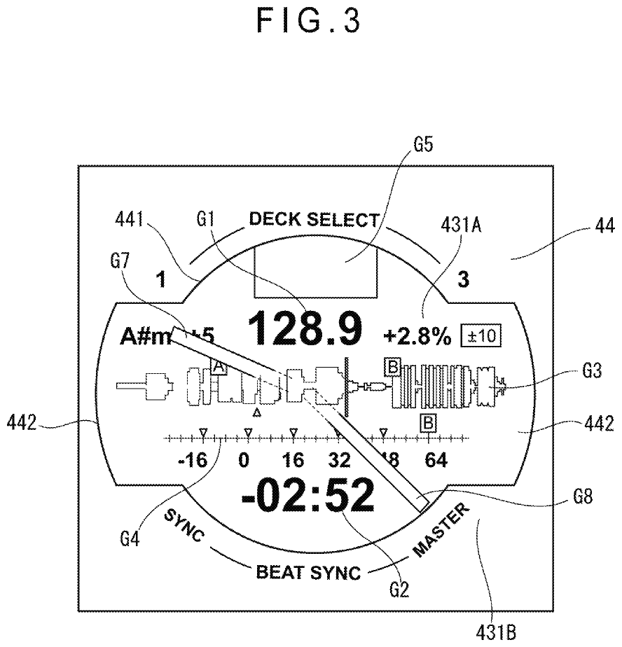

In the first display area 431A, in addition to a BPM image (Beats Per Minute) G1 of the currently reproduced music piece data, an elapsed time image G2 of the currently reproduced music piece data, a state-of-progress image G3 of the currently reproduced music piece data, and a beat position image G4 of the currently reproduced music piece data, an image G5 that shows designed manufacturer name, product name, etc. of the DJ controller 4 may be displayed as shown in FIG. 3.

In addition, a rotary display image G7 is displayed in the first display area 431A, rotating at a speed similar to 33 RPM, that is, a rotation speed of the LP record, during the reproduction of the music piece data. When the jog dial 421 is operated, a displayed position of the rotary display image G7 also moves in accordance with an operation amount. Further, a marker image G8 is displayed in the first display area 431A, allowing the operator to see a position of a CUE point or the like by setting a position of the marker image G8 at a desired position.

The second display area 431B is covered with the mask 44.

The mask 44 has a circular window 441 around the rotation center of the jog dial 421 and an extension window 442 projecting outward from each of right-direction and left-direction ends of the circular window 441 and a portion where the circular window 441 and the extension window 442 are defined serves as a display area of the first display area 431A.

In addition, the mask 44 is printed with characters of DECK SELECT and BEAT SYNC and, further, provided with a portion in a character cutout shape indicating 1, 3, and SYNC MASTER, that is, a transmissive portion. The mask 44 is in a form of a light shielding film obtained by vapor-depositing metal onto a surface of a transparent resin film, while the circular window 441, the extension window 442, and the portion in the character cutout shape are masked during the vapor-depositing of the metal.

The second display area 431B is configured to display a predetermined monochrome image. For instance, a portion immediately under one of the character cutouts indicating 1 or 3 for DECK SELECT is lit in red or the like at an upper portion of the second display area 431B, thereby allowing the operator to see a currently reproduced channel in the deck 42L. Similarly, a portion immediately under one of the character cutout portions indicating MASTER or SYNC for BEAT SYNC is lit in red or the like at a lower portion of the second display area 431B, thereby allowing the operator to see a BPM synchronization state in the deck 42L.

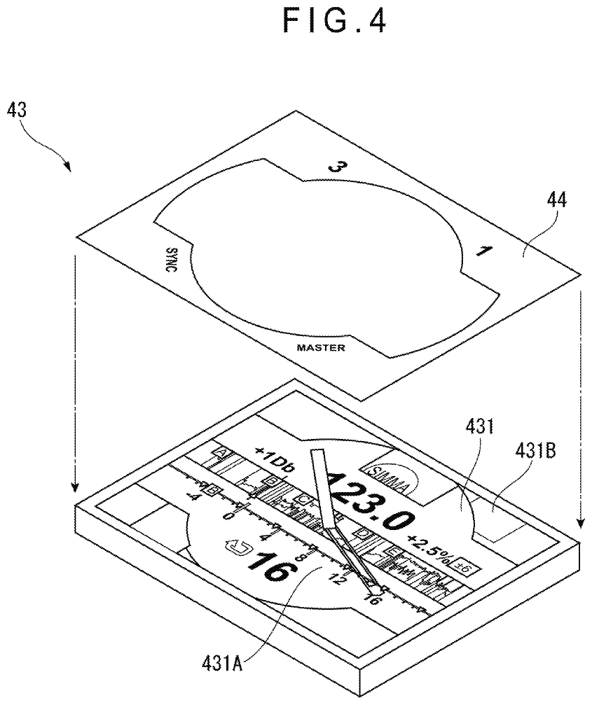

Such a display 43 can be produced by bonding the mask 44 previously provided with the character cutouts onto the display area 431 of the display 43 as shown in FIG. 4.

It should be noted that the image formed in the second display area 431B is not limited to a monochromatic image in red or the like, but a gradational image or an image with a small pattern may be formed and/or an emission color, an emission intensity, or both may be changed.

The transmissive portion formed in the mask 44 is not limited to the portion in the character cutout shape, a portion in a number shape, and the like but may be a sign-shaped cutout and a lexigram-shaped cutout.

### [3] Operations and Effects of Exemplary Embodiment

Such an exemplary embodiment achieves the following effects.

The second display area 431B is covered with the mask 44 provided with the character cutouts that is the transmissive portion. This makes it possible to freely change an emission color, an emission intensity, and any other emission image in the second display area 431B to provide the display 43 with high decorativeness. Therefore, the DJ controller 4 is allowed to have a fancy illumination decoration, thereby providing sound equipment with high decorativeness.

Light of the second display area 431B passing through the character cutout of the mask 44 illuminates a character cutout surface of the mask 44, approaches a user as compared with an actual emission surface of the liquid crystal display of the display 43. This can enhance visibility of the character cutout of the second display area 431B.

Further, since the display 43 is concentrically located around the rotation center of the jog dial 421 (i.e., the rotary operation unit), the DJ controller 4 can be user-friendly, allowing the operator to see the BPM, the beat position, the elapsed time, etc. of the currently reproduced music piece data while operating the jog dial.

Since the mask 44 has the circular window 441 and the extension window 442, the rotary display image G7 and the marker image G8 can be displayed on the circular window 441. It is thus possible to display a rotation of the rotary display image G7 according to the operation of the jog dial 421 and display a rotational position of the marker image G8 with CUE setting Meanwhile, horizontally long image data such as the state-of-progress image G3 and the beat position image G4 of the music piece data can be displayed on the extension window 442. Thus, since the horizontally long image data can be displayed using the extension window 442, the operator can see the state of progress, etc. of long-duration music piece data and present DJ performance.

### [4] Modifications of Exemplary Embodiment

It should be noted that the invention is not limited to the above exemplary embodiment and the following modifications fall within the scope of the invention.

In the above exemplary embodiment, the display 43 is provided in each of the decks 41L and 41R of the DJ controller 4; however, the invention is not limited thereto. Specifically, a display according to the invention may be implemented in sound equipment such as a record player or a mixer.

Further, in the above exemplary embodiment, the display 43 is provided at the rotation center of the jog dial 421; however, the invention is not limited thereto. A display according to the invention may be provided at any other portion of a device body of a DJ controller.

In addition, regarding a specific structure, shape, etc. for implementation of the invention, any other structure, etc. may be employed as long as an object of the invention is achievable.

### EXPLANATION OF CODES

1 . . . music piece data reproduction control system, 2 . . . computer, 3 . . . USB cable, 4 . . . DJ controller, 31 . . . storage, 41 . . . mixer, 41L . . . deck, 41R . . . deck, 42 . . . mixer, 42L . . . deck, 42R . . . deck, 43 . . . display, 44 . . . mask, 411 . . . first channel, 411 . . . first channel adjuster, 412 . . . second channel adjuster, 413 . . . third channel adjuster, 414 . . . fourth channel adjuster, 414 . . . fourth channel, 415 . . . microphone adjuster, 416 . . . effect selection switch, 417 . . . channel selection switch, 418 . . . effect-amount adjusting switch, 419 . . . effect adding switch, 421 . . . jog dial, 422 . . . tempo slider, 423 . . . performance pad, 424 . . . CUE button, 425 . . . play/pause button, 426 . . . loop button, 427 . . . deck selection button, 428 . . . load button, 431 . . . display area, 431A . . . first display area, 431B . . . second display area, 432 . . . ring, G2 . . . elapsed time, G3 . . . state of progress, G4 . . . beat position, G5 . . . image data, G7 . . . rotary display image, G8 . . . marker image

1. Sound equipment comprising:
a display; and
a mask covering a part of the display, wherein
the display comprises: a first display area where an image is to be freely displayed; and a second display area covered with the mask, and
the mask comprises a transmissive portion configured to transmit light emitted from the second display area.

2. The sound equipment according to claim 1, wherein
the transmissive portion is in a character shape or a sign shape and the second display area emits the light with a change in an emission color and an emission intensity.

3. The sound equipment according to claim 1, further comprising a rotary operation unit rotatably provided to a device body, the rotary operation unit being provided with the display.
